(19) United States
(12) Patent Application Publication
(10) Pub. No.: US 2012/0019891 A1
(43) Pub. Date: Jan. 26, 2012

(54) Window Having A Selective Light Modulation System

(76) Inventor: Douglas A. Dewell, Mission Viejo, CA (US)

(21) Appl. No.: 12/841,172

(22) Filed: Jul. 22, 2010

(51) Int. Cl. G02F 1/153

(52) U.S. Cl. 359/275

(57) ABSTRACT

An electrochromic vehicular window system having a multiplicity of individually electrically switchable electrochromic elements, a vehicle operator face (eye) sensor to determine the position of the face of the operator in the vehicle, a sensor of the source external light entering the vehicle and impinging on the operators eyes and a system processor utilizing data from the sensors to determine and control which portions of the electrochromergic window to activate (or deactivate) so as to automatically reduce or eliminate glare on the eyes of the operator while still allowing essentially normal light transmission through other sections of the window. The system can also include a control switch for manual operation and or limiting the degree of light attenuation.

### BACKGROUND OF THE INVENTION

1. Field of the Invention

The present invention relates generally to a “smart” window particularly useful for selectively limiting or eliminating glare caused by bright light in cars and aircraft.

2. Description of Related Art

The present invention relates to an electrically controlled chromergic system particularly useful in auto and aircraft windshields to selectively reduce the glare directed on the operators eyes due to sunlight or other bright lights while still allowing light not falling on the operators eyes to freely enter the vehicle.

Chromogenic materials controllable by an electric potential include electrochromic (EC) materials that change from an essentially transparent state to a colored light absorbing state as well as certain metal hydrides which change their reflectivity in response to an applied voltage and dichroic liquid crystals which change the transmission of polarized light in response to an applied field. Chromogenic materials have attracted widespread interest in applications relating to the transmission of light. These materials have been incorporated into various devices and systems including both house and vehicular windows. Such devices have included manual control of the transmitted light as well as photoconductor automated control of the transmitted light. However, the prior art devices do not selectively modulate only those portions of the device that are in the direct field of vision of the operator. Rather, they modulate light transmission throughout the window. This is an important distinction between the present invention and the prior art in that it is generally preferable to reduce glare in the operators eyes without reducing the overall amount of available light. This is especially true if one is driving from bright sunshine and going into a tunnel with minimal light or when driving at night and one wants to reduce glare from an oncoming headlight without significantly reducing the overall road light.

Several different distinct types of EC materials are known. Three primary types are: inorganic thin films, organic polymer films, and metal hydride (Ni/Mg hydrides) layers. For inorganic thin film-based EC devices, the EC layer is typically tungsten oxide (WO.sub.3). U.S. Pat. Nos. 5,598,293; 6,005,705; and 6,136,161 describe an inorganic thin film EC device based on a tungsten oxide EC layer. Other inorganic EC materials, such as molybdenum oxide and vanadium oxide, are also known. Conjugated, redox-active polymers represent another type of EC material. These polymers (cathodic or anodic polymers) are inherently electrochromic and can be switched electrochemically or chemically, between different color states. A family of redox-active copolymers are described in U.S. Pat. No. 5,883,220. Another family of nitrogen based heterocyclic organic EC materials is described in U.S. Pat. No. 6,197,923. Other known organic based electrochromic materials include pyridine compounds, aminoquinone compounds and azine compounds. Research into still other types of organic film EC materials continues, in hopes of identifying or developing EC materials that will be useful in EC windows.

Generally, electrochromic devices employ materials capable of reversibly altering their optical properties following electrochemical oxidation and reduction in response to an applied potential. Except for liquid crystal devices which are responsive to the application of an electric field, the optical modulation is the result of the simultaneous insertion and extraction of electrons and charge compensating ions in the electrochemical material lattice.

To make an EC device that exhibits different opacities in response to an applied voltage, a multilayer assembly is required. In general, the two outer layers of the assembly are transparent electronic conductors. Within the outer layers is a counter-electrode layer and an EC layer, between which is disposed an ion conductor layer. When a low voltage is applied across the outer conductors, ions moving from the counter-electrode to the EC layer cause the assembly to change color. Reversing the voltage moves ions from the EC layer back to the counter-electrode layer, restoring the device to its previous state and color. All of the layers are preferably transparent to visible light. Examples of EC devices can be found with reference to U.S. Pat. No. 7,593,154 of Burdis et al and Takahashi (U.S. Pat. No. 4,293,194).

Various optical systems have been proposed employing chromergic devices. For example, Breed, et al, in U.S. Pat. No. 7,734,061 discloses an optical occupant sensing technique in a vehicular system for determining the presence of an object in a passenger compartment of the vehicle. The system includes a first image receiver arranged at a first location for obtaining a first two-dimensional view of a portion of the compartment, and a second image receiver arranged at a second location for obtaining a second two-dimensional view of the same portion of the compartment, the second image receiver being arranged relative to the first image receiver such that three dimensions of the portion of the compartment are encompassed by the first and second views. A processor receives images from the first and second image receivers and determines whether an object is present in the compartment based on the images. A reactive system, such as an airbag assembly, may be coupled to the processor and controlled thereby based on the determination of whether an object is present in the imaged portion of the compartment.

Zehner, et al., U.S. Pat. No. 7,733,335 describes methods for driving bistable electro-optic displays, and apparatus for use therein. More particularly there is described a bistable electro-optic display having a plurality of pixels, each of which is capable of displaying at least three gray levels. The display is driven by a method comprising: storing a look-up table containing data representing the impulses necessary to convert an initial gray level to a final gray level; storing data representing at least an initial state of each pixel of the display; receiving an input signal representing a desired final state of at least one pixel of the display; and generating an output signal representing the impulse necessary to convert the initial state of said one pixel to the desired final state thereof, as determined from said look-up table.

It should be noted that the present invention can employ any type of reversibly electrically activated chromergic material. Further the references cited are incorporated herein by reference.

### SUMMARY OF THE INVENTION

The novel invention comprises an electrochromergic vehicular window having electrically switchable chromergic elements, a vehicle operator face (eye) sensor to determine the position of the operator in the vehicle, a sensor of the source external light entering the vehicle and impinginging on the operators eyes and a system processor utilizing data from the sensors to determine and control which portions of the electrochromergic window to activate (or deactivate) so as to automatically reduce or eliminate glare on the eyes of the operator while still allowing essentially normal light transmission through other sections of the window. The system can also include a control switch for manual operation and or limiting the degree of light attenuation.

The foregoing has outlined the present invention so that those skilled in the art may better understand the detailed description of the invention that follows. Additional features of the invention will be described hereinafter that form the subject of the various claims of the invention. Those skilled in the art should appreciate that they can readily use the conception and specific embodiment as a base for designing or modifying the structures for carrying out the same purposes of the present invention and that such other features do not depart from the spirit and scope of the invention in its broadest form.

### BRIEF DESCRIPTION OF THE DRAWINGS

Other aspects, features, and advantage of the present invention will become more fully apparent from the following detailed description, the appended claims, and the accompanying drawings in which similar elements are given similar reference numerals.

FIG. 1 is a top view of the inside of a vehicle employing the system of the current invention to modulate incoming sunlight;

FIG. 2 is a side view of the embodiment shown in FIG. 1;

FIG. 3 is side view of the embodiment of FIG. 1 when applied to protection against the high beam of an oncoming vehicle; and

FIG. 4, depicts use of the invention in an aircraft.

### DETAILED DESCRIPTION OF THE INVENTION

The primary function of the present invention is to provide reversible light attenuation through a window of a vehicle such that light is selectively attenuated through those areas of the window so as to substantially reduce or eliminate glare in the vehicle operators eyes while allowing light in other areas of the window to remain essentially unattenuated. This feature is especially important at times when one is travelling from a bright area into a dark area, such as a tunnel or at night when the system is primarily used to minimize glare from oncoming headlights. The area requiring attenuation is dependent not only upon the direction from which the light is emanating, but also upon the position of the operator in his or her seat relative to the angle of entry of the light. Consequently, the present invention must include, in addition to a light modulator such as an elctrochromic type device having a multiplicity of individually reversibly activatable pixels or elements or groups of elements, a light source sensor capable of measuring the intensity of the light source as well as its angle of ingress and a second sensor to determine the position of the face (eyes) of the operator of the vehicle and a processor which accepts signals from the sensors and controls which electrochromic elements to selectively activate or deactivate. As used herein, the term electrochromic window is meant to include any voltage controlled window that can reversibly modulate the transmission of light passing through the window. This therefore includes but is not necessarily limited to inorganic as well as organic based redox type electrochromic materials and devices as well as hydride type reflective materials devices and light polarizing liquid crystal materials and devices.

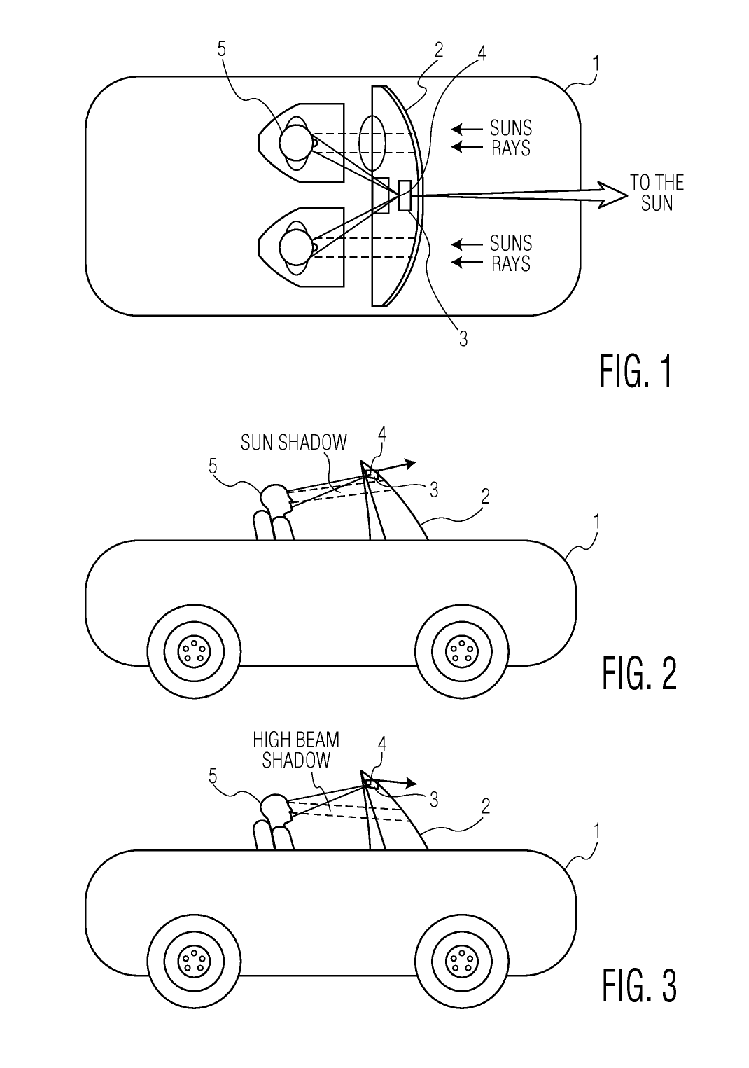

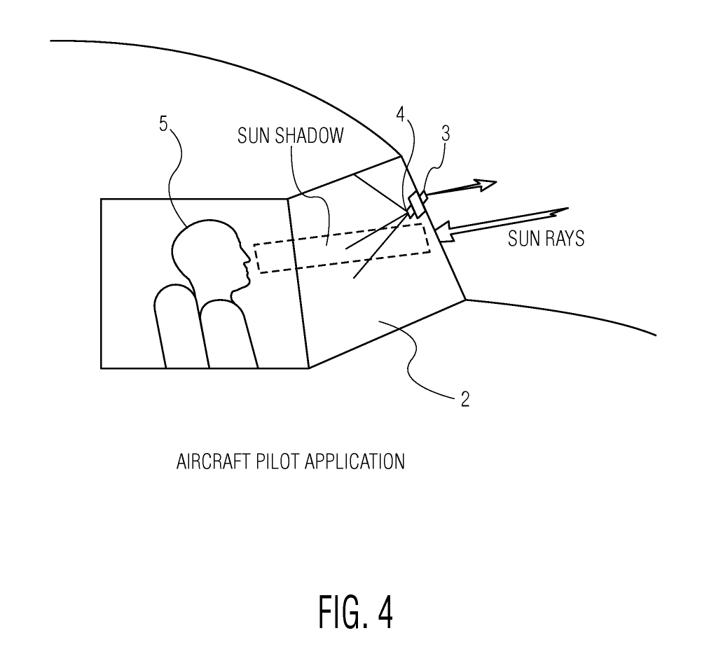

Referring to FIGS. 1-3, there are shown views of a light modulation system employing the present invention in an automotive vehicle. FIG. 4 is directed to essentially the same system employed with respect to its use in an aircraft.

Referring to FIGS. 1-3, there are shown top and side views of an automobile 1 having a windshield 2 which incorporates electrochromic device layers (not separately shown) therein or thereon as are well known in the art. These layers include a multiplicity of separately activatible photochromic elements or pixels. Mounted on or near the inside of the windshield 2 is a forward facing sun (light) sensor 3 and rearward facing face sensor 4. As shown, the two sensors 3 and 4 are mounted within a common housing preferably situated on or in the vicinity of the central upper portion of the windshield. The light sensor 3 measures the intensity and position of the light impinging on the vehicle from the sun or from opposing headlights. The face sensor 4 determines the position of the face of the vehicle operator 5 and optionally of any person sitting alongside the operator 5. The data garnered from the sensors 3 and 4 are provided to a remote processor 6 which determines and controls which electrochromic elements in the windshield 2 to activate and to what degree of transmission so as to substantially selectively reduce or eliminate glare to the operator (and passenger where provided) without unnecessarily depleting light in areas that would not effect the operator's 5 vision. Hence, the darkened or activated areas are those between the light source and the front seat occupants eyes. The processor 6 may be mounted within the cabin of the vehicle or in some remote area. The processor 6 may optionally include or be coupled to a manual control to allow the operator 5 to manually adjust the degree of light attenuation or over ride the automatic adjustment as determined by the processor 6. In order to see traffic signals that are in line with the sun, the operator may have to reduce the degree of attenuation otherwise developed by the processor. As can be seen with reference to FIG. 3, when the system is used for reducing the glare of oncoming headlights, the area of the windshield which is activated would be below the area that would be activated to reduce sun glare as depicted in FIG. 2.

FIG. 4 shows the system as applied to an aircraft.

The Figures depict the “shadow path” which is the section of the windscreen that is darkened to reduce or eliminate the glare which would otherwise be caused by the external light.

The various layers necessary to form the electrochromic attenuator are preferably formed either within the windshield structure or over the inner surface of the windshield. Since electrochromic devices as are currently known in the art do not require high voltages, the power necessary for their operation can easily be supplied by the vehicles power system. Sensors useful in the invention include but are not limited to photoconductor type sensors, infra red sensors, laser sensors and the type of light sensors commonly used in video cameras, all of which are well known in the art.

What is claimed is:

1. A switchable light attenuation system for a vehicle comprises an electrochromergic vehicular window having electrically switchable chromergic elements, a first sensor to determine the location of the face of the operator of the vehicle, a second sensor to determine the direction of the source external light entering the vehicle and impinging on the operators eyes, and a system processor utilizing data from said first and second sensors to determine and control which elements of the electrochromergic window to activate or deactivate so as to automatically control or eliminate glare on the eyes of the operator while still allowing essentially normal light transmission through other sections of the window.

2. The system set forth in claim 1 wherein the chromergic elements comprises an electrochromic material.

3. The system set forth in claim 2 wherein the electrochromic material is an inorganic oxide having at least two valence states, one of which is transparent to visible light and another which absorbs visible light.

4. The system described in claim 3 wherein the oxide is a member of the group consisting of tungsten oxide, molybdenum oxide and vanadium oxide.

5. The system described in claim 2. wherein the electrochromic material is a conjugated redox activated organic polymer.

6. The system described in claim 2 wherein the electrochromic material is a metal hydride whose reflectivity is voltage modulated.

7. The system described in claim 2 wherein the electrochromic material is a liquid crystal.

8. A switchable light attenuation system for a vehicle comprises an electrochromergic vehicular window having electrically switchable chromergic elements, a first sensor to determine the location of the faces of the front occupants of the vehicle, a second sensor to determine the direction of the source external light entering the vehicle and impinging on the occupants eyes, and a system processor utilizing data from said first and second sensors to determine and control which elements of the electrochromergic window to activate or deactivate so as to automatically control or eliminate glare on the eyes of the occupants while still allowing essentially normal light transmission through other sections of the window.

9. The system set forth in claim 1 wherein the first and second sensors are combined in a unitary housing.

10. The system set forth in claim 9 wherein the housing is mounted inside the vehicle in the vicinity of the central upper portion of the windshield.

11. The system set forth in claim 1 further including a manually operated control for adjusting the degree of light transmission through the window.

12. The system set forth in claim 8 further including a manually operated control for adjusting the degree of light transmission through the window.

13. The system set forth in claim 9 wherein the chromergic elements are of a class selected from the group consisting of metal oxides, metal hydrides, organic polymers and liquid crystals.

14. The system set forth in claim 8 wherein a three color display of light from an obscured traffic light or a multi-segment display of a traffic condition such as STOP, GO, SLOW is provided on the vehicle window
